(19) United States
(12) Patent Application Publication
(10) Pub. No.: US 2008/0304120 A1
(43) Pub. Date: Dec. 11, 2008

(54) Hologram recording medium and manufacturing method therefor

(75) Inventors: Naoki Hayashida, Tokyo (JP); Atsuko Kosuda, Tokyo (JP); Jiro Yoshinari, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/155,304

(22) Filed: Jun. 2, 2008

(30) Foreign Application Priority Data
Jun. 5, 2007 (JP) 2007-149660

(51) Int. Cl. G03H 1/02; G03H 1/04

(52) U.S. Cl. 359/3; 430/2

(57) ABSTRACT

A hologram recording medium includes a support substrate, a hologram recording material layer, a transparent gel layer, and a protective substrate. The transparent gel layer is formed of a resin material gelated by cross-linking, or more specifically, such as gelated silicone cross-linked by hydrosilylation or gelated polyurethane cross-linked by polyaddition of isocyanic ester to alcohol. The transparent gel layer serves as a filler to compensate for variations in thickness of the hologram recording material layer. The transparent gel layer fills those gaps occurring between the recording material layer of the hologram recording medium and the adjacent substrate, without having adverse effects on the recording characteristics, in a manner that allows for controlling the refractive index.

### BACKGROUND OF THE INVENTION

1. Field of the Invention

The present invention relates to a hologram recording medium which is improved in its recording characteristics and to a manufacturing method therefor.

2. Description of the Related Art

A hologram recording medium of an organic/inorganic hybrid material is provided with a structure usable as a medium. In forming the structure, use is made of a filler (serving also as a refractive index control layer). The filler fills gaps that occur between a hologram recording material layer and a protective substrate (or support substrate) due to variations in thickness (bumps and dips) of the hologram recording material layer. The bumps and dips are thereby turned into a truly flat surface. For example, in Japanese Patent Application Laid-Open No. 2005-165054, it is suggested to use an organic silicone (silicone oil) as the filler.

However, it was found that the aforementioned silicone oil in a liquid state permeates the hologram recording material layer, and thus has adverse effects on its recording characteristics.

### SUMMARY OF THE INVENTION

In view of the foregoing problems, various exemplary embodiments of this invention provide a filler serving also as a refractive index control layer for a hologram recording medium of an organic/inorganic hybrid material. In forming a structure usable as a medium, the filler fills gaps, which occur in between a recording material layer and a protective substrate, without adversely affecting its recording characteristics.

As a result of intensive studies, the present inventors found that the aforementioned problems can be addressed by using a resin material gelated by cross-linking as a filler serving also as a refractive index control layer. More specifically, it was found that a resin material could be used to compensate for variations in thickness of the hologram recording material layer and thereby form a truly flat plane without having adverse effects on the recording characteristics of the hologram recording medium. Here, the resin material includes a silicone gel cross-linked by hydrosilylation or a polyurethane gel cross-linked by polyaddition of isocyanic ester to alcohol. More specifically, the foregoing object has been achieved by the following aspects of the present invention.

In summary, the above-described objectives are achieved by the following embodiments of the present invention.

(1) A hologram recording medium comprising: a support substrate; a hologram recording material layer which has no flowability at room temperatures before being exposed to a write beam of light; and a transparent gel layer being inert to read and write beams at least after having been implemented in a form of a recording medium, in which the support substrate, the hologram recording material layer, and the transparent gel layer are provided in that order.

(2) The hologram recording medium according to (1), further comprising a protective substrate, and wherein the support substrate, the hologram recording material layer, the transparent gel layer, and the protective substrate are provided in that order.

(3) The hologram recording medium according to (1), further comprising a first support substrate identical to the support substrate, a first hologram recording material layer, a second hologram recording material layer, and a second support substrate identical to the support substrate, and wherein the first support substrate, the first hologram recording material layer, the transparent gel layer, the second hologram recording material layer, and the second support substrate are provided in that order.

(4) The hologram recording medium according to any one of (1) to (3), wherein the transparent gel layer is formed by polymerization of a low molecular-weight compound having flowability at room temperatures.

(5) The hologram recording medium according to any one of (2) to (4), wherein a relation of equations (1) and (2) below is satisfied;

|n₀−n_{g}|≦|n₀−n₁| (1), and

|n₁−n_{g}|≦|n₀−n₁| (2),

where no is a refractive index of the hologram recording material layer at wavelengths of the read and write beams; n₁ is a refractive index of the support substrate or the protective substrate at the wavelengths of the read and write beams, and n_{g} is a refractive index of the transparent gel layer at the wavelengths of the read and write beams.

(6) The hologram recording medium according to any one of (1) to (5), wherein the hologram recording material layer is formed of a composition containing a product of hydrolysis and subsequent condensation reactions of a metal alkoxide and a photopolymerizable monomer.

(7) A method for manufacturing a hologram recording medium whose hologram recording material layer before being exposed to a write beam of light has no flowability at room temperatures, the method comprising the steps of: preparing a support substrate having the hologram recording material layer formed on one surface; preparing a protective substrate having a transparent gel layer formed on one surface; and bonding together the support substrate having the hologram recording material layer formed thereon and the protective substrate having the transparent gel layer formed thereon, so that the hologram recording material layer and the transparent gel layer are brought into contact with each other.

(8) A method for manufacturing a hologram recording medium whose hologram recording material layer before being exposed to a write beam of light has no flowability at room temperatures, the method comprising the steps of: preparing a transparent gel precursor composition having flowability at room temperatures; bonding together a support substrate having the hologram recording material layer formed on one surface and a protective substrate using the transparent gel precursor composition so that a surface of the hologram recording material layer and a surface of the protective substrate oppose to each other; and gelating the transparent gel precursor composition filled in between the hologram recording material layer and the protective substrate.

(9) A method for manufacturing a hologram recording medium whose hologram recording material layer before being exposed to a write beam of light has no flowability at room temperatures, the method comprising the steps of: preparing a first support substrate having a first hologram recording material layer formed thereon; preparing a second support substrate having a second hologram recording material layer and a transparent gel layer formed on one surface so that the transparent gel layer is located at an outermost position; and bonding together the first support substrate and the second support substrate so that the first hologram recording material layer and the transparent gel layer are brought into contact with each other.

(10) A method for manufacturing a hologram recording medium whose hologram recording material layer before being exposed to a write beam of light has no flowability at room temperatures, the method comprising the steps of: preparing a transparent gel precursor composition having flowability at room temperatures; bonding together a first support substrate having a first hologram recording material layer formed on one surface and a second support substrate having a second hologram recording material layer formed on one surface using the transparent gel precursor composition, so that a surface of the first hologram recording material layer and a surface of the second hologram recording material layer oppose to each other; and gelating the transparent gel precursor composition filled in between the first hologram recording material layer and the second hologram recording material layer.

(11) A hologram recording medium having a support substrate and a hologram recording material layer provided thereon, the hologram recording material layer having variations in thickness, wherein the hologram recording material layer is provided thereon with a transparent gel layer, the transparent gel layer compensating for variations in thickness of a surface of the hologram recording material layer and thus having a flat upper surface.

(12) The hologram recording medium as set forth in (11), wherein the transparent gel layer is provided on its upper surface with a protective substrate.

(13) The hologram recording medium according to (11), further comprising a first support substrate which is identical to the support substrate; a first hologram recording material layer which is identical to the hologram recording material layer; the transparent gel layer; a second hologram recording material layer which is identical to the hologram recording material layer; and a second support substrate which is identical to the support substrate, in which the first support substrate, the first hologram recording material layer, the transparent gel layer, the second hologram recording material layer, and the second support substrate are provided in that order.

(14) The hologram recording medium according to any one of (11) to (13), wherein the transparent gel layer is formed by polymerization of a low molecular-weight compound having flowability at room temperatures.

(15) The hologram recording medium according to any one of (11) to (14), wherein a relation of equations (1) and (2) below is satisfied;

|n₀−n_{g}|≦|n₀−n₁| (1), and

|n₁−n_{g}|≦|n₀−n₁| (2),

where no is a refractive index of the hologram recording material layer at wavelengths of the read and write beams; n₁ is a refractive index of the support substrate or the protective substrate at the wavelengths of the read and write beams, and n_{g} is a refractive index of the transparent gel layer at the wavelengths of the read and write beams.

(16) The hologram recording medium according to any one of (11) to (15), wherein the hologram recording material layer is formed of a composition containing a product of hydrolysis and subsequent condensation reactions of a metal alkoxide and a photopolymerizable monomer.

(17) A method for manufacturing a hologram recording medium, comprising the steps of: forming a hologram recording material layer on an upper surface of a support substrate; forming a transparent gel layer on an upper surface of a protective substrate; and bonding together the support substrate and the protective substrate to bring the hologram recording material layer and the transparent gel layer into contact with each other, so that the transparent gel layer fills bumps and dips of the hologram recording material layer to compensate for variations in thickness caused by the bumps and dips.

The present invention provides a hologram recording medium formed of an organic/inorganic hybrid material which employs a gelated resin material as a filler for filling gaps occurring in between a hologram recording material layer and a protective substrate (or support substrate). The gelated resin material is used as a filler serving also as a refractive index control layer to compensate for variations in thickness of the hologram recording material layer and forming a truly flat plane, thereby making it possible to provide a hologram recording medium that shows good recording characteristics.

### BRIEF DESCRIPTION OF THE DRAWINGS

FIG. 1 is a schematic cross-sectional view illustrating a hologram recording medium according to first and second exemplary embodiments of the present invention;

FIG. 2 is a schematic cross-sectional view illustrating a hologram recording medium according to third and fourth exemplary embodiments of the present invention;

FIG. 3 is a schematic cross-sectional view illustrating a hologram recording medium according to fifth exemplary embodiments of the present invention;

FIG. 4 is a schematic cross-sectional view illustrating the steps of manufacturing the hologram recording medium according to the first exemplary embodiment of the present invention;

FIG. 5 is a schematic cross-sectional view illustrating the steps of manufacturing the hologram recording medium according to the second exemplary embodiment of the present invention;

FIG. 6 is a schematic cross-sectional view illustrating the steps of manufacturing the hologram recording medium according to the third exemplary embodiment of the present invention;

FIG. 7 is a schematic cross-sectional view illustrating the steps of manufacturing the hologram recording medium according to the fourth exemplary embodiment of the present invention;

FIG. 8 is a schematic block diagram illustrating the configuration of a hologram recording optical system which is used to evaluate hologram recording media according to an exemplary embodiment of the present invention and a comparative example.

### DETAILED DESCRIPTION OF THE PREFERRED EMBODIMENTS

The aforementioned object is achieved by providing a hologram recording medium that is configured as follows. That is, the hologram recording medium has a support substrate, a hologram recording material layer, a transparent gel layer, and a protective substrate, which are formed in that order. A reflective film is formed in between the support substrate and the hologram recording material layer. An antireflective film is formed on a surface of at least one of the support substrate and the protective substrate, the surface being opposite to the side on which the hologram recording material layer has been formed. The transparent gel layer is formed by polymerization of a low molecular-weight compound having flowability at room temperatures. The transparent gel layer compensates for variations in thickness of the hologram recording material layer to form a truly flat plane, and is inert to read and write beams at least after having been implemented in the form of a hologram recording medium.

### First Exemplary Embodiment

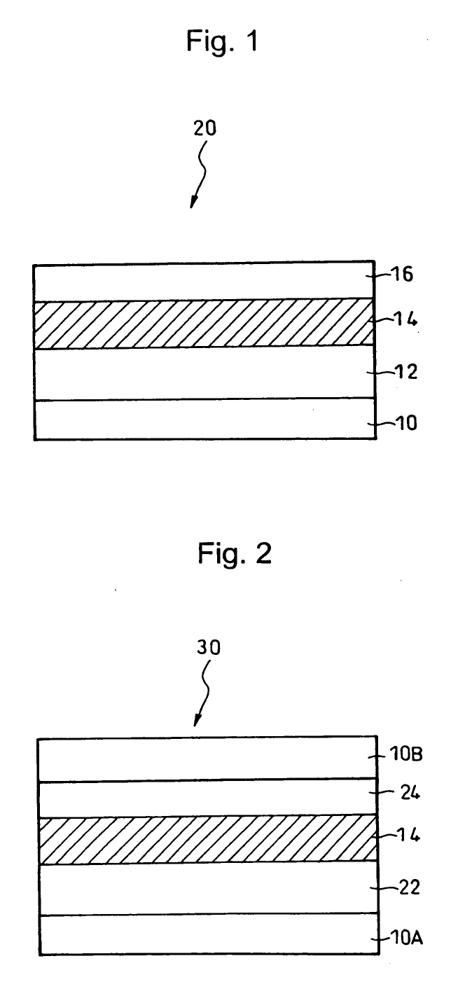

As shown in FIG. 1, a hologram recording medium 20 according to a first exemplary embodiment of the present invention is configured to include a support substrate 10, a hologram recording material layer 12, a transparent gel layer 14, and a protective substrate 16, which are formed in that order. The hologram recording material layer 12 has no flowability at room temperatures before being exposed to a write beam of light. Here, the room temperatures refer to temperatures of 15° C. or higher to 25° C. or lower, and preferably around 20° C. Furthermore, “having no flowability” can be best referred to when the hologram recording material layer 12 is covered with the protective substrate 16 that is rigid and flat. That is, it refers to a state of flowability being lost to such an extent that the self-weight or less of the protective substrate 16 does not sufficiently pressurize the hologram recording material layer 12 for the bumps and dips of its surface to follow the protective substrate 16, thereby causing the gaps between the hologram recording material layer 12 and the protective substrate 16 to be unfilled. Accordingly, the hologram recording material layer 12 is determined to have lost flowability unless those gaps are filled within a reasonable period of time during which the hologram recording medium 20 is manufactured (i.e., in about a few seconds to one minute).

Specifically, a “gel” is defined as not having the flowability equivalent to that defined in the foregoing but having a transmittance of 80% or more of hologram read and write beams (when passing through the thickness of the gel). That is, suppose that a hardened transparent material layer is brought into intimate contact with the protective substrate 16 that is rigid and flat or the hologram recording material layer 12. In this case, the transparent gel layer 14 is defined as the transparent material layer which has lost its flowability to such an extent that it cannot fill the gaps between the transparent material layer and the protective substrate 16 or the hologram recording material layer 12. The gaps cannot be filled because a pressure equal to or less than the self-weight of the protective substrate 16 is not enough for the bumps and dips on a surface of the transparent material layer to follow the protective substrate 16 or the hologram recording material layer 12 within about a few seconds or one minute. When acted upon by a pressure greater than the self-weight of the protective substrate 16, the transparent gel layer 14 can be deformed along the variations in thickness (bumps and dips) of the hologram recording material layer 12, so that it can compensate the variations in thickness and thereby make the surface truly flat. Furthermore, at least after having been implemented in the form of the hologram recording medium 20, the transparent gel layer 14 is inert to read and write beams and thus does not affect its optical read and write characteristics.

Now, a description will be made to a method for manufacturing a hologram recording material solution which is used to form the hologram recording material layer 12 of the hologram recording medium 20 according to an exemplary embodiment of the present invention.

First, to obtain a matrix material, 7.9 g of diphenyl dimethoxy silane and 7.2 g of poly-Ti(OBu) (B-10 by Nippon Soda Co., Ltd.) expressed by structural formula (a) below were mixed to provide a metal alkoxide liquid mixture with the molar ratio of Ti/Si being 1/1;

C₄H₉—[OTi(OC₄H₉)₂]ₖ—OC₄H₉ (k=10) (a)

Next, a solution containing 1.0 ml of water, 0.3 ml of 1N hydrochloric acid aqueous solution, and 7.0 ml of 1-methoxy-2-propanol was dropwise added to the metal alkoxide liquid mixture at room temperatures while being stirred, and kept being stirred for two hours for hydrolysis and condensation reactions, thereby preparing a solated solution. The solated solution was employed as a matrix material. Here, the ratio of the metal alkoxide starting material to the whole reacting solution was 67 mass %.

Then, 100 weight parts of polyethylene glycol diacrylate (Aronix M-245 by Toagosei Co., Ltd.) were mixed with 3 weight parts of Irgacure 907 (by Chiba Specialty Chemicals) serving as a photopolymerization initiator and 0.3 mass parts of thioxanthen-9-one serving as a sensitizer to obtain a photopolymerizable compound.

Furthermore, the solated solution and the photopolymerizable compound were mixed at room temperatures so that the ratio of the nonvolatile matrix material was 67 weight parts and the ratio of the photopolymerizable compound was 33 weight parts. In this manner, a hologram recording material solution which was substantially transparent colorless was obtained. Here, the room temperatures refer to temperatures of 10° C. or higher to 30° C. or lower, and preferably around 20° C.

Now, a description will be made to a method for preparing the support substrate 10, on which the hologram recording material layer 12 is formed, of the hologram recording medium 20 according to an exemplary embodiment of the present invention.

First prepared was a crown glass substrate having a thickness of 1 mm with an antireflective film provided on one surface. This crown glass substrate has a refractive index of 1.523 at a wavelength of 405 nm. On the other surface of the crown glass substrate on which no antireflective film is provided, a spacer having a predetermined thickness was placed, and then the hologram recording material solution obtained was applied thereon. The whole assembly was dried for one hour at room temperatures, and then further dried for 48 hours at 40° C. to volatilize the solvent. This drying step allows the gelation (condensation reaction) of the organometallic compound to proceed, thereby providing the support substrate 10 having a hologram recording material layer of a dried coat thickness of 400 μm formed thereon, in which the organometallic compound and the photopolymerizable compound are uniformly distributed.

Next, 1,4-bis(dimethylsilyl)benzene (LS-7310 by Shin-Etsu Chemical Co., Ltd.), diphenyldivinylsilane (LS-5900 by Shin-Etsu Chemical Co., Ltd.), and 1,1,3,3-tetraphenyl-1,3-divinyl disiloxane (LS-8092 by Shin-Etsu Chemical Co., Ltd.) were added to transparent potting gelated silicone (KE-1051J by Shin-Etsu Chemical Co., Ltd.) to prepare a transparent gel precursor composition. The hardened coating had a refractive index of 1.531 at a wavelength of 405 nm. Note that the refractive index was measured using Prism Coupler Model-2010 by Metricon, USA.

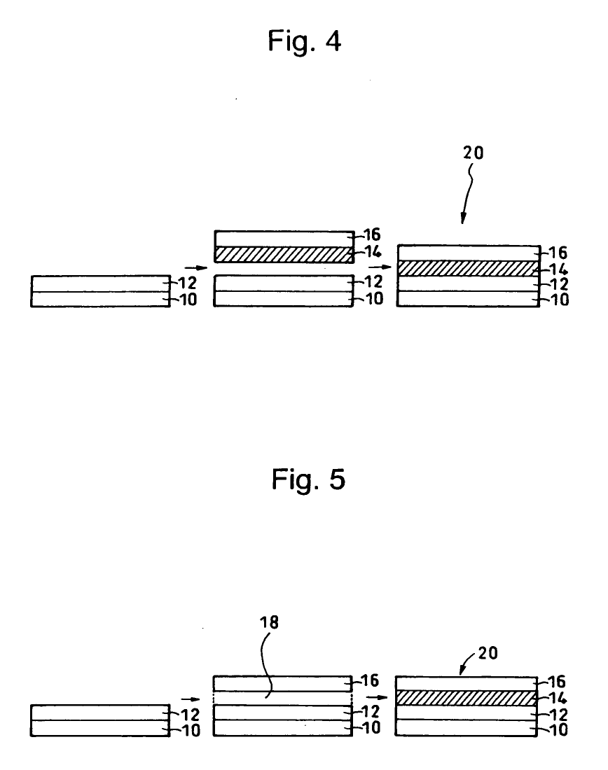

In practice, more than one method can be followed to use the support substrate 10 having the hologram recording material layer 12 formed thereon and the transparent gel precursor composition to actually fabricate them in the form of the hologram recording medium 20 shown in FIG. 1. For example, the transparent gel layer 14 of silicone or urethane may be formed in advance on the protective substrate 16. Then, the resulting subassembly may be brought into intimate contact with the hologram recording material layer 12 formed on the support substrate 10, thereby preparing the hologram recording medium 20 (FIG. 4). Alternatively, the support substrate 10 with the hologram recording material layer 12 formed thereon and the protective substrate 16 may be bonded to each other, for example, using the transparent gel precursor composition of gelated silicone or gelated polyurethane. Then, the resulting subassembly may be cross-linked and gelated, thereby preparing the hologram recording medium 20 (FIG. 5).

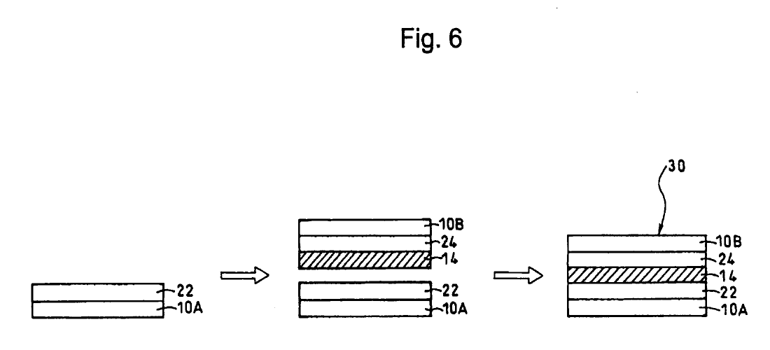

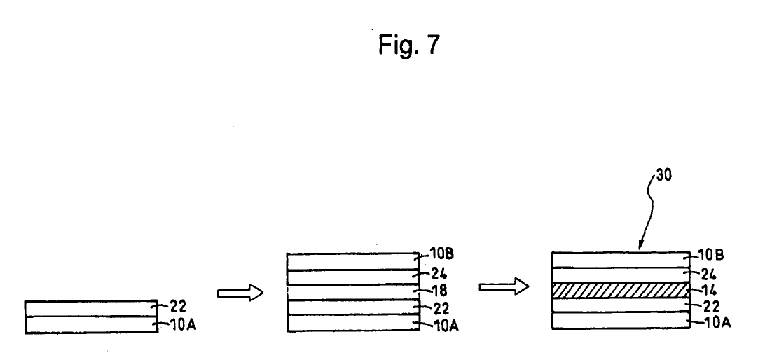

Alternatively, a second hologram recording material layer 24 and the transparent gel layer 14 may be formed in advance on a second support substrate 10B which is identical to the support substrate 10. Then, the resulting subassembly may be brought into intimate contact with a first hologram recording material layer 22 formed on a first support substrate 10A which is identical to the support substrate 10, thereby preparing a two-layer hologram recording medium 30 (FIG. 6). Alternatively, the first support substrate 10A having the first hologram recording material layer 22 formed thereon and the second support substrate 10B having the second hologram recording material layer 24 formed thereon may be bonded to each other, for example, using the transparent gel precursor composition of gelated silicone or gelated polyurethane. Subsequently, the resulting subassembly may be cross-linked and gelated, thereby preparing the two-layer hologram recording medium 30 (FIG. 7). Note that using the methods shown in FIG. 6 and FIG. 7 would result in the first hologram recording material layer 22 and the second hologram recording material layer 24 being separated by the transparent gel layer 14 that lies therebetween. However, this configuration can be thought to have no significantly adverse effects on the read and write characteristics so long as the thickness (about a few μm to 100 μm) and the refractive index of the gel layer lie within a predetermined range.

Now, a description will be made to the exemplary embodiments of the present invention and comparative examples.

The hologram recording medium 20 according to the first exemplary embodiment was obtained following the method shown in FIG. 4.

More specifically, spacers of a predetermined thickness were placed on the surface of the crown glass substrate on which no antireflective film had been formed, and then the transparent gel precursor composition was applied thereon to a thickness of 100 μm and hardened. After that, the spacers were removed to obtain the protective substrate 16 on which the transparent gel layer 14 had been formed.

Then, the protective substrate 16 was placed on the surface of the support substrate 10, on which the hologram recording material layer 12 prepared in advance had been formed, so that the transparent gel layer 14 and the hologram recording material layer 12 were brought into contact with each other. Both the substrates were sufficiently pressurized at room temperatures to remove bubbles at the interface. After that, the resulting subassembly was left standing overnight at room temperatures, so that the hologram recording material layer 12 and the transparent gel layer 14 conformed to each other.

In this manner, the hologram recording medium 20 was obtained which was provided with the transparent gel layer 14 on the hologram recording material layer 12.

### Second Exemplary Embodiment

The hologram recording medium 20 according to a second exemplary embodiment was obtained following the method shown in FIG. 5.

More specifically, spacers of a predetermined thickness were placed on the surface of the crown glass substrate on which no antireflective film was formed, and then the transparent gel precursor composition was applied thereon to a thickness of 100 μm. In this manner, the protective substrate 16 was obtained on the surface of which a transparent gel precursor layer 18 was placed.

Then, the protective substrate 16 was placed on the surface of the support substrate 10, on which the hologram recording material layer 12 prepared in advance had been formed, so that the transparent gel precursor layer 18 and the hologram recording material layer 12 were brought into contact with each other. After that, the resulting subassembly was left standing overnight at room temperatures, so that the transparent gel precursor composition was hardened.

In this manner, the hologram recording medium 20 was obtained which was provided with the transparent gel layer 14 on the hologram recording material layer 12.

### Third Exemplary Embodiment

The two-layer hologram recording medium 30 according to a third exemplary embodiment was configured as shown in FIG. 2 and obtained following the method shown in FIG. 6. In FIG. 2, the components identical to those of the first exemplary embodiment will be indicated with the same symbols as those of the first exemplary embodiment, and will not be described as appropriate.

More specifically, prepared were the first support substrate 10A and the second support substrate 10B, both identical to the support substrate 10 and having the hologram recording material layer formed thereon respectively. The transparent gel precursor composition was applied to a thickness of 50 μm on the surface of the hologram recording material layer (the second hologram recording material layer 24) formed on the second support substrate 10B, and then hardened. The second support substrate 10B was thus obtained on which the second hologram recording material layer 24 and the transparent gel layer 14 had been formed.

Then, the resulting subassembly was placed so that the first hologram recording material layer 22 formed on the first support substrate 10A and the transparent gel layer 14 were brought into contact with each other. Both the substrates were sufficiently pressurized at room temperatures to remove bubbles at the interface. After that, the resulting subassembly was left standing overnight at room temperatures, so that the first hologram recording material layer 22 and the transparent gel layer 14 conformed to each other.

In this manner, the two-layer hologram recording medium 30 was obtained which had the first hologram recording material layer 22 and the second hologram recording material layer 24 bonded to each other by means of the transparent gel layer 14.

### Fourth Exemplary Embodiment

The two-layer hologram recording medium 30 according to a fourth exemplary embodiment was configured as shown in FIG. 2 and obtained following the method shown in FIG. 7.

More specifically, prepared were the first support substrate 10A and the second support substrate 10B, both identical to the support substrate 10 and having the hologram recording material layer formed thereon respectively. The transparent gel precursor composition was applied to a thickness of 50 μm on the surface of the hologram recording material layer (the second hologram recording material layer 24) formed on the second support substrate 10B. The second support substrate 10B was thus obtained on which the second hologram recording material layer 24 and the transparent gel precursor layer 18 had been formed.

Then, the resulting subassembly was placed so that the first hologram recording material layer 22 formed on the first support substrate 10A and the transparent gel precursor layer 18 were brought into contact with each other. After that, the resulting subassembly was left standing overnight at room temperatures, so that the transparent gel precursor layer 18 was hardened to serve as the transparent gel layer 14.

In this manner, the two-layer hologram recording medium 30 was obtained which had the first hologram recording material layer 22 and the second hologram recording material layer 24 bonded to each other by means of the transparent gel layer 14.

Note that in the hologram recording medium according to the first to fourth exemplary embodiments, the reflective film may be formed on the surface of the support substrate on which the hologram recording layer has been formed. Alternatively, the antireflective film may also be formed on a surface of at least one of the support substrate and the protective substrate, which is opposite to the surface on which the hologram recording material layer has been formed. In this case, both the reflective film and the antireflective film may also be formed. For example, a fifth exemplary embodiment to be discussed below may also be employed.

### Fifth Exemplary Embodiment

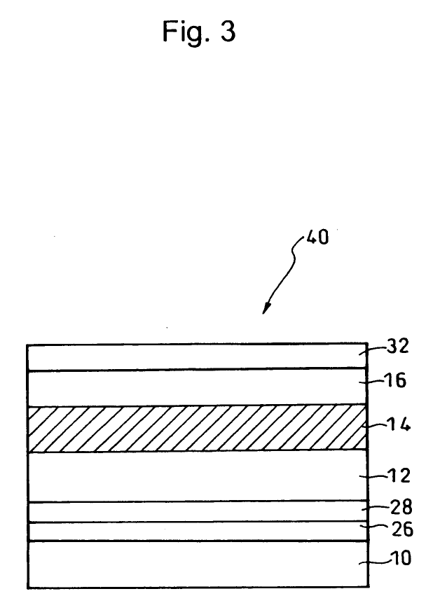

A hologram recording medium 40 according to the fifth exemplary embodiment was configured as shown in FIG. 3 and obtained following the method below. In FIG. 3, the components identical to those of the first exemplary embodiment will be indicated with the same symbols as those of the first exemplary embodiment, and will not be described as appropriate.

A hologram recording material solution was obtained in the same manner as in the first to fourth exemplary embodiments except that the photopolymerizable compound used was obtained by mixing 100 weight parts of polyethylene glycol diacrylate (Aronix M-245 by TOAGOSEI Co., Ltd.) with 3 weight parts of Irgacure 784 (by Chiba Specialty Chemicals) serving as a photopolymerization initiator. Then, a crown glass substrate was prepared as the support substrate 10 on which a reflective film 26 of Al and a protective coating 28 of SiO₂ had been formed in that order. Then, on the surface of the support substrate 10 toward the protective coating 28, formed was the hologram recording material layer 12 using the hologram recording material solution prepared. The other steps were followed in the same manner as in the first exemplary embodiment to obtain the hologram recording medium 40 which had the transparent gel layer 14 provided on the hologram recording material layer 12. In the hologram recording medium 40, there is formed an antireflective film 32 on the surface of the protective substrate 16, which is opposite to the hologram recording material layer 12.

### First Comparative Example

A hologram recording medium according to a first comparative example was obtained using silicone oil following the same method as that of the first exemplary embodiment.

More specifically, 1,1,3,5,5-pentaphenyl-1,3,5-trimethyl trisiloxane (LS-8580 by Shin-Etsu Chemical Co., Ltd.) was added to silicone oil (KF-54 by Shin-Etsu Chemical Co., Ltd.) to prepare a silicone oil composition.

Then, spacers of a predetermined thickness were placed on the surface of the crown glass substrate on which no antireflective film had been formed, and then the silicone oil composition was applied thereon to a thickness of 50 μm. After that, the spacers were removed to obtain a protective substrate on which the silicone oil layer had been formed.

Then, the protective substrate was placed on the surface of the support substrate, on which the hologram recording material layer had been formed, so that the silicone oil layer and the hologram recording material layer were brought into contact with each other. After that, the resulting subassembly was left standing overnight at room temperatures, so that recording material layer and the silicone oil layer conformed to each other. In this manner, the hologram recording medium was obtained which was provided with the silicone oil layer on the hologram recording material layer. When visually observed, the surface of the hologram recording material layer looked whitish.

### Second Comparative Example

A hologram recording medium according to a second comparative example employed bisphenol-A-type epoxy resin (EPICLON 850-S by DIC Corporation with a viscosity of 11000-15000 mPa·s at 25° C.) instead of the silicone oil composition. The other steps were followed as in the first comparative example to obtain the hologram recording medium which was provided with the epoxy resin layer on the hologram recording material layer.

### Third Comparative Example

The mixture ratio of transparent potting gelated silicone (KE-1051J by Shin-Etsu Chemical Co., Ltd.), 1,4-bis(dimethylsilyl)benzene (LS-7310 by Shin-Etsu Chemical Co., Ltd.), diphenyl divinyl silane (LS-5900 by Shin-Etsu Chemical Co., Ltd.), and 1,1,3,3-tetraphenyl-1,3-divinyl disiloxane (LS-8092 by Shin-Etsu Chemical Co., Ltd.) was adjusted as appropriate to prepare the transparent gel precursor composition such that the hardened coating had a refractive index of 1.509 at λ=405 nm. Except for this transparent gel precursor composition, the same components as those of the first exemplary embodiment were employed to obtain the hologram recording medium.

### Fourth Comparative Example

A hologram recording medium was obtained which was configured in the same manner as in the fifth exemplary embodiment except that the same silicone oil as that used for the first comparative example was employed instead of the mixture of the transparent potting gelated silicone, the 1,4-bis(dimethylsilyl)benzene, the diphenyl divinyl silane, and the 1,1,3,3-tetraphenyl-1,3-divinyl disiloxane.

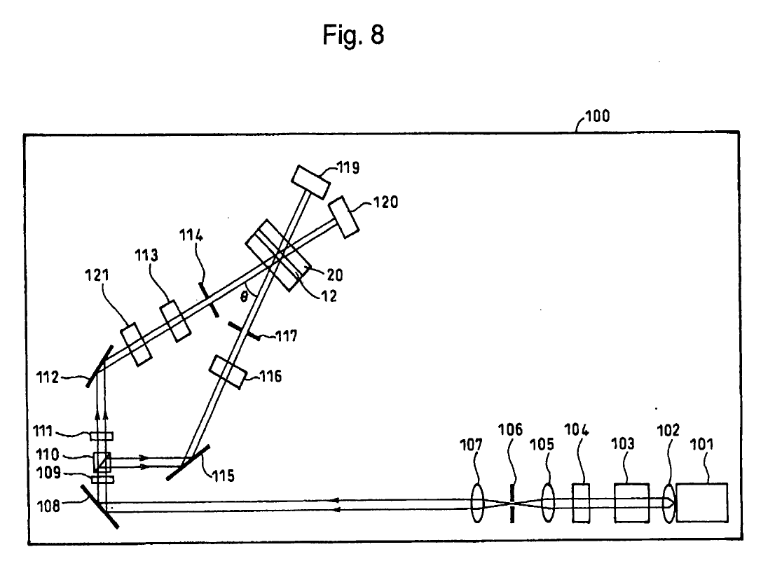

With each of the hologram recording media obtained in the aforementioned exemplary embodiments and comparative examples, evaluations on their characteristics were made twice, i.e., immediately after they were prepared and one week after they were left standing since then at room temperatures. The evaluations were conducted using a hologram recording optical system 100 shown in FIG. 8.

Now, a description will be made in more detail to a specific method for making the characteristic evaluations. Here, for convenience, a direction parallel to the surface of FIG. 8 is defined as the horizontal direction.

As shown in FIG. 8, the hologram recording medium 20 according to the first and second exemplary embodiments was so set that the hologram recording material layer 12 was perpendicular to the horizontal direction. The hologram recording optical system 100 employs a light source 101 or a semiconductor laser (405 nm) which provides lasing in a single mode. The light emitted from the light source 101 was filtered and collimated spatially through a beam rectifier 102, an optical isolator 103, a shutter 104, a convex lens 105, a pin hole 106, and a convex lens 107, and then expanded to a beam of approximately 10 mmφ in diameter. A 45-degree polarized beam was extracted from the expanded beam via a mirror 108 and a half-wave plate 109, and then split into an S wave and a P (1:1) through a polarizing beam splitter 110. The split S wave was directed to the hologram recording medium 20 via a mirror 115, a polarizing filter 116, and an iris diaphragm 117. The split P wave was converted into the S wave using a half-wave plate 111 and then also directed to the hologram recording medium 20 via a mirror 112, a polarizing filter 113, and an iris diaphragm 114. Those beams were incident on the hologram recording medium 20 at a total angle of incidence θ of 37 degrees, and the interference pattern between the two beams were recorded on the hologram recording medium 20.

The hologram was recorded while the hologram recording medium 20 was rotated in the horizontal direction at multiplexed angular intervals (the angle of rotation from −21 degrees to +21 degrees at angular intervals of 0.6 degrees). The number of multiplexed angular intervals was 71. During recording, the hologram recording medium 20 was exposed to the beams with the iris diaphragm set to a diameter of 4 mm. Note that the position at which the surface of the hologram recording medium 20 is at a 90 degrees to the line bisecting the angle θ formed by the two beams is defined as the position at which the angle of rotation is +/−0 degree.

After the hologram was recorded, the hologram recording medium 20 was irradiated sufficiently with a blue LED at a wavelength of 400 nm for the remaining unreacted components to react. At this time, the hologram recording medium 20 was exposed to the irradiation via an acrylic resin diffusing plate of a transmittance of 80% so that the irradiation beam would not have coherence (this is called “post cure”).

During readout, a shutter 121 was used to block the beams, so that the hologram recording medium 20 was irradiated with only one beam with the iris diaphragm 117 set to a diameter of 1 mm. While the hologram recording medium 20 was continuously rotated from −23 degrees to +23 degrees in the horizontal direction, the diffraction efficiency at the respective angular positions was measured using a power meter 120. With no changes in the volume (recording caused contraction) and the average refractive index of the hologram recording material layer before and after recording, the horizontal diffraction peak angles coincide with each other during recording and readout. However, in practice, since a recording caused contraction or a change in average refractive index occurs, the horizontal diffraction peak angle during readout is slightly different from the horizontal diffraction peak angle during recording. Thus, during readout, the horizontal angle was continuously varied to thereby determine the diffraction efficiency based on the peak intensity of a diffraction peak when appeared. These characteristic evaluations were also made on the two-layer hologram recording medium 30 according to the third to fourth exemplary embodiments, the hologram recording medium 40 according to the fifth exemplary embodiment, and the hologram recording medium according to the respective comparative examples.

Furthermore, to know the angle selectivity of hologram recording, read and write evaluations were made on a single hologram. That is, with the sample angle fixed to 0 degree, the interference pattern of the two beams was recorded so that the diffraction rate was about 5% during readout. After the hologram recording, the hologram recording medium was irradiated sufficiently with a blue LED at a wavelength of 400 nm for the remaining unreacted components to react. Then, while the hologram recording medium was continuously rotated from −5 degrees to +5 degrees in the horizontal direction, the diffraction efficiency at the respective angular positions was measured using the power meter 120.

The measured diffraction efficiencies were plotted against the angular positions of the hologram recording medium to read the half-width θ₂. On the other hand, in the aforementioned multiplexed recording hologram, the half-width θ₁ of the first diffraction peak was also read to determine the spread of angle selectivity R_{angle} during the multiplexed operation based on Equation (b) below. If this value is smaller, the medium can be said to be better in low noise property during multiplexed recording. Note that this measurement was made only immediately after the medium was prepared.

R_{angle}=(θ₁−θ₂)/θ₁ (b)

On the other hand, FIG. 8 shows a power meter 119 which is not used in the exemplary embodiments.

The measurement results are shown in Table 1.

Here, the diffraction efficiency is indicated in terms of M/#(M number).

M/# is equivalent to a dynamic rage of the recording medium, and defined by the equation below using the diffraction efficiency (ηᵢ) of each multiplexed signal which is observed when a multiplexed recorded signal is read.

M/#=Σ(ηᵢ)^{1/2}

That is, the total sum of square roots of diffraction efficiencies is M/#.

TABLE 1

| | | | After one week at |
|---|---|---|---|
| | | Initial | room temperature |
| First exemplary | M/# (in terms of 1 | 22.5 | 22.1 |
| embodiment | mm in thickness) | | |
| | Transmittance [%] | 78.5 | 76.2 |
| | Rangle [%] | 14 | — |
| Second exemplary | M/# (in terms of 1 | 21.8 | 21.6 |
| embodiment | mm in thickness) | | |
| | Transmittance [%] | 77.6 | 77.6 |
| | Rangle [%] | 11 | — |
| Third exemplary | M/# (in terms of 1 | 23.4 | 23.5 |
| embodiment | mm in thickness) | | |
| | Transmittance [%] | 65.2 | 64.8 |
| | Rangle [%] | 18 | — |
| Fourth exemplary | M/# (in terms of 1 | 22.9 | 22.8 |
| embodiment | mm in thickness) | | |
| | Transmittance [%] | 64.6 | 63.2 |
| | Rangle [%] | 16 | — |
| First comparative | M/# (in terms of 1 | 19.8 | 16.7 |
| example | mm in thickness) | | |
| | Transmittance [%] | 24.8 | 19.8 |
| | Rangle [%] | 28 | — |
| Second comparative | M/# (in terms of 1 | 21.8 | 12.6 |
| example | mm in thickness) | | |
| | Transmittance [%] | 79.5 | 80.5 |
| | Rangle [%] | 16 | — |
| Third comparative | M/# (in terms of 1 | 23.6 | 22.9 |
| example | mm in thickness) | | |
| | Transmittance [%] | 75.3 | 75.9 |
| | Rangle [%] | 23 | — |

As can be seen from Table 1, when compared with the media immediately after being prepared, those after having been left standing for one week at room temperatures show deterioration in the diffraction efficiency (M/#) and transmittance for the first comparative example and in the diffraction efficiency for the second comparative example.

In contrast to this, the samples of the first to fourth exemplary embodiments show no distinct differences in both the diffraction efficiency and the transmittance between immediately after being prepared and after having been left standing for one week at room temperatures.

The angle selectivity (R_{angle}) is 14% for the first exemplary embodiment, whereas it is 28% for the first comparative example and 16% for the second comparative example, both of which correspond to the first exemplary embodiment. Furthermore, it is 11% for the second exemplary embodiment, whereas 23% for the third comparative example which corresponds thereto.

Accordingly, the comparative examples have a higher value when compared with the exemplary embodiments in terms of the angle selectivity. This shows that the hologram recording media according to the comparative examples have a higher noise level during multiplexed recording.

Degradation in transmittance and diffraction efficiency or an increase in the value of angle selectivity is equivalent to degradation in recording characteristics. Accordingly, the first to fourth exemplary embodiments can be said to have not degraded in recording characteristics because of no degradation in diffraction efficiency and transmittance and a comparatively small value of angle selectivity.

In contrast to this, the first and second comparative examples can be said to have degraded in recording characteristics because of degradation in diffraction efficiency and transmittance and a comparatively high value of angle selectivity.

Then, page-data read and write evaluations were made using the collinear scheme on the hologram recording medium 40 according to the fifth exemplary embodiment and the hologram recording medium according to the fourth comparative example. For read and write operations, a collinear holographic medium evaluation system SHOT-1000 by Pulstec Industrial Co., Ltd. (at a read and write wavelength of 532 nm) was used to read and write a single page of data. The quality of a reproduced signal is given as SNR (Signal to Noise Ratio).

The hologram recording medium 40 had an SNR of 3.5, and the hologram recording medium according to the fourth comparative example had an SNR of 1.3. Since higher values of SNR show better recording characteristics, it can be seen that the fifth exemplary embodiment provides better recording characteristics than the fourth comparative example.

Note that the transparent gel layer is not limited to those of the exemplary embodiments formed by the addition reaction of a monomer or macro-monomer having a —SiH group and a monomer or macro-monomer having a vinyl group and/or an ethynyl group. The transparent gel layer may be any one so long as it is formed by polymerization of a low molecular-weight compound having flowability at room temperatures. For example, the transparent gel layer may be one that is formed by the addition reaction of an isocyanic ester monomer or macro-monomer thereof and a monomer or macro-monomer having a hydroxyl group.

Furthermore, it is also preferable to control the refractive index of the transparent gel layer within a predetermined range. For example, a hologram recording medium can exhibit good recording characteristics by satisfying the relations expressed by Equations (1) and (2) below;

|n₀−n_{g}|≦|n₀−n₁| (1), and

|n₁−n_{g}|≦|n₀−n₁| (2),

where n₀ is the refractive index of the hologram recording material layer at the wavelength of read and write beams, n₁ is the refractive index of the support substrate or the protective substrate at the wavelength of the read and write beams, and n_{g} is the refractive index of the transparent gel layer at the wavelength of the read and write beams.

For example, as described above, in the exemplary embodiments, the crown glass substrate used as the support substrate or the protective substrate has a refractive index n₁=1.523 at a wavelength of 405 nm, the hardened coating has a refractive index n_{g}=1.531 at a wavelength of 405 nm, and the hologram recording material layer has an average refractive index n₀=1.621, as measured, at a wavelength of 405 nm. Thus,

|n₀−n_{g}|=0.090,

|n₁−n_{g}|=0.008, and

|n₀−n₁|=0.098,

which satisfy the relations expressed by Equations (1) and (2).

In contrast to this, as described above, in the third comparative example, the hardened coating has a refractive index n_{g}=1.509 at a wavelength of 405 nm. Thus,

|n₀−n_{g}|=0.112,

|n₁−n_{g}|=0.014, and

|n₀″n₁|=0.098,

which satisfy the relation expressed by Equation (2) but not the relation expressed by Equation (1).

Note that the support substrate and the protective substrate may be either the same or different from each other. The substrates are referred to with different names only for convenience. In the manufacturing process of the hologram recording medium, the substrate (or base material) that is first used is called the “support substrate.” On the other hand, such a base material is called the “protective substrate” that is provided to sandwich a hologram recording material layer or the like between it and the support substrate after the hologram recording material layer or the like has been formed on the support substrate.

Accordingly, in the third and fourth exemplary embodiments, the support substrates each having a hologram recording material layer formed thereon are bonded to each other so that the hologram recording material layers face to each other, thereby preparing a hologram recording medium. Thus, both sides of the hologram recording medium are the support substrates.

Furthermore, the aforementioned exemplary embodiments are directed to a one-layer or two-layer hologram recording medium. However, in the case of a microhologram or a read and write system in which individual holograms are recorded as a single bit, the present invention is also applicable to multi-layered hologram recording media of three or more layers.

In the case of the microhologram, recording bit arrays are stacked in layers at predetermined intervals in the vertical direction. It is thus theoretically no problem to provide optically inert transparent layers between the layers to form a multi-layered structure. Accordingly, there is a certain advantage in forming the multi-layered structure of multiple recording layers and a transparent layer(s) in order to improve the optical transmittance of the recording layers as a whole or to reduce crosstalk between the layers.

What is claimed is:

1. A hologram recording medium comprising:
a support substrate;
a hologram recording material layer which has no flowability at room temperatures before being exposed to a write beam of light; and
a transparent gel layer being inert to read and write beams at least after having been implemented in a form of a recording medium, in which the support substrate, the hologram recording material layer, and the transparent gel layer are provided in that order.

2. The hologram recording medium according to claim 1, further comprising a protective substrate, and wherein the support substrate, the hologram recording material layer, the transparent gel layer, and the protective substrate are provided in that order.

3. The hologram recording medium according to claim 1, further comprising a first support substrate identical to the support substrate, a first hologram recording material layer, a second hologram recording material layer, and a second support substrate identical to the support substrate, and wherein the first support substrate, the first hologram recording material layer, the transparent gel layer, the second hologram recording material layer, and the second support substrate are provided in that order.

4. The hologram recording medium according to claim 1, wherein the transparent gel layer is formed by polymerization of a low molecular-weight compound having flowability at room temperatures.

5. The hologram recording medium according to claim 2, wherein the transparent gel layer is formed by polymerization of a low molecular-weight compound having flowability at room temperatures.

6. The hologram recording medium according to claim 3, wherein the transparent gel layer is formed by polymerization of a low molecular-weight compound having flowability at room temperatures.

7. The hologram recording medium according to claim 2, wherein a relation of equations (1) and (2) below is satisfied;

|n₀−n_{g}|≦|n₀−n₁| (1), and

|n₁−n_{g}|≦|n₀−n₁| (2),
where n₀ is a refractive index of the hologram recording material layer at wavelengths of the read and write beams; n₁ is a refractive index of the support substrate or the protective substrate at the wavelengths of the read and write beams, and n_{g} is a refractive index of the transparent gel layer at the wavelengths of the read and write beams.

8. The hologram recording medium according to claim 3, wherein a relation of equations (1) and (2) below is satisfied;

|n₀−n_{g}|≦|n₀−n₁| (1), and

|n₁−n_{g}|≦|n₀−n₁| (2),
where n₀ is a refractive index of the hologram recording material layer at wavelengths of the read and write beams; n₁ is a refractive index of the support substrate or the protective substrate at the wavelengths of the read and write beams, and n_{g} is a refractive index of the transparent gel layer at the wavelengths of the read and write beams.

9. The hologram recording medium according to claim 4, wherein a relation of equations (1) and (2) below is satisfied;

|n₀−n_{g}|≦|n₀−n₁| (1), and

|n₁−n_{g}|≦|n₀−n₁| (2),
where n₀ is a refractive index of the hologram recording material layer at wavelengths of the read and write beams; n₁ is a refractive index of the support substrate or the protective substrate at the wavelengths of the read and write beams, and n_{g} is a refractive index of the transparent gel layer at the wavelengths of the read and write beams.

10. The hologram recording medium according to claim 1, wherein the hologram recording material layer is formed of a composition containing a product of hydrolysis and subsequent condensation reactions of a metal alkoxide and a photopolymerizable monomer.

11. The hologram recording medium according to claim 2, wherein the hologram recording material layer is formed of a composition containing a product of hydrolysis and subsequent condensation reactions of a metal alkoxide and a photopolymerizable monomer.

12. The hologram recording medium according to claim 3, wherein the hologram recording material layer is formed of a composition containing a product of hydrolysis and subsequent condensation reactions of a metal alkoxide and a photopolymerizable monomer.

13. The hologram recording medium according to claim 4, wherein the hologram recording material layer is formed of a composition containing a product of hydrolysis and subsequent condensation reactions of a metal alkoxide and a photopolymerizable monomer.

14. The hologram recording medium according to claim 7, wherein the hologram recording material layer is formed of a composition containing a product of hydrolysis and subsequent condensation reactions of a metal alkoxide and a photopolymerizable monomer.

15. A method for manufacturing a hologram recording medium whose hologram recording material layer before being exposed to a write beam of light has no flowability at room temperatures, the method comprising the steps of:
preparing a support substrate having the hologram recording material layer formed on one surface;
preparing a protective substrate having a transparent gel layer formed on one surface; and
bonding together the support substrate having the hologram recording material layer formed thereon and the protective substrate having the transparent gel layer formed thereon, so that the hologram recording material layer and the transparent gel layer are brought into contact with each other.

16. A method for manufacturing a hologram recording medium whose hologram recording material layer before being exposed to a write beam of light has no flowability at room temperatures, the method comprising the steps of:
preparing a transparent gel precursor composition having flowability at room temperatures;
bonding together a support substrate having the hologram recording material layer formed on one surface and a protective substrate using the transparent gel precursor composition so that a surface of the hologram recording material layer and a surface of the protective substrate oppose to each other; and
gelating the transparent gel precursor composition filled in between the hologram recording material layer and the protective substrate.

17. A method for manufacturing a hologram recording medium whose hologram recording material layer before being exposed to a write beam of light has no flowability at room temperatures, the method comprising the steps of:
preparing a first support substrate having a first hologram recording material layer formed thereon;
preparing a second support substrate having a second hologram recording material layer and a transparent gel layer formed on one surface so that the transparent gel layer is located at an outermost position; and
bonding together the first support substrate and the second support substrate so that the first hologram recording material layer and the transparent gel layer are brought into contact with each other.

18. A method for manufacturing a hologram recording medium whose hologram recording material layer before being exposed to a write beam of light has no flowability at room temperatures, the method comprising the steps of:
preparing a transparent gel precursor composition having flowability at room temperatures;
bonding together a first support substrate having a first hologram recording material layer formed on one surface and a second support substrate having a second hologram recording material layer formed on one surface using the transparent gel precursor composition, so that a surface of the first hologram recording material layer and a surface of the second hologram recording material layer oppose to each other; and
gelating the transparent gel precursor composition filled in between the first hologram recording material layer and the second hologram recording material layer.
